(19) United States
(12) Patent Application Publication
(10) Pub. No.: US 2005/0262018 A1
(43) Pub. Date: Nov. 24, 2005

(54) Business method for internet advertising

(76) Inventor: Kevin Soria, Washoe County, NV (US)

Correspondence Address: Brian Kelly, 555 S. Center St., Reno, NV, 89501, US

(21) Appl. No.: 10/849,336

(22) Filed: May 18, 2004

(51) Int. Cl. G06F 17/60

(52) U.S. Cl. 705/40; 705/26

(57) ABSTRACT

The applicant has presented a business method to improve advertising return incorporating paying referral fees directly to customers and gathering information on tendencies to increase target resolution of ads.

### FIELD OF INVENTION

This invention relates generally to the field of Internet marketing.

### BACKGROUND OF INVENTION

The Internet has become pervasive. Marketers attempt to attract individuals to their web sites in order to execute transactions. In the previous field of advertising by radio, TV or print, the ad would reach many people who are unlikely to be interested; and, even if they are, more activity is required on their part to get even close to a closing.

The Internet allows an advertiser to get a person in the virtual door and close a transaction much more quickly with little effort on the customer's part.

One of the driving aspects of Internet advertising is the click through, where a customer visits one site and can be directed to another site by activating a virtual button. Presently site operators are paid for click throughs. The Applicant has devised a method of sharing this revenue with the potential customer. With the higher level of value for the advertiser, click throughs have become lucrative to site operators.

### OBJECTS OF THE INVENTION

A first object of the invention is to provide a method for customers to share in the benefit of their attention and patronage.

A second object of the invention is to provide a customer profiled to fit the advertiser allowing a more selective and possibly more successful advertising transaction.

### BRIEF DESCRIPTION OF DRAWINGS

FIG. 1 shows a representation of a computer screen.

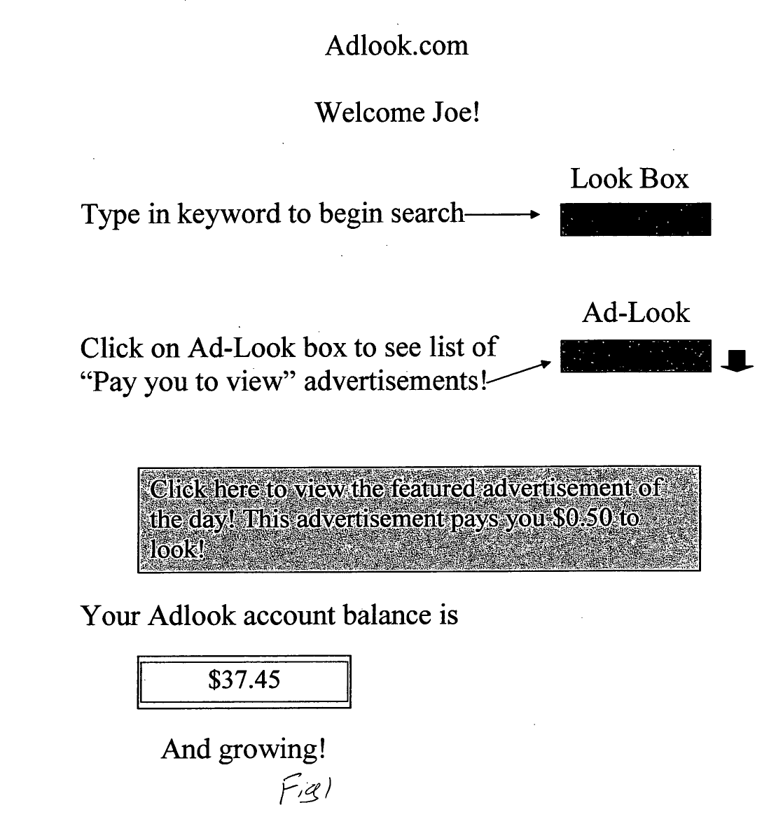

FIG. 2 shows a representation of a computer screen.

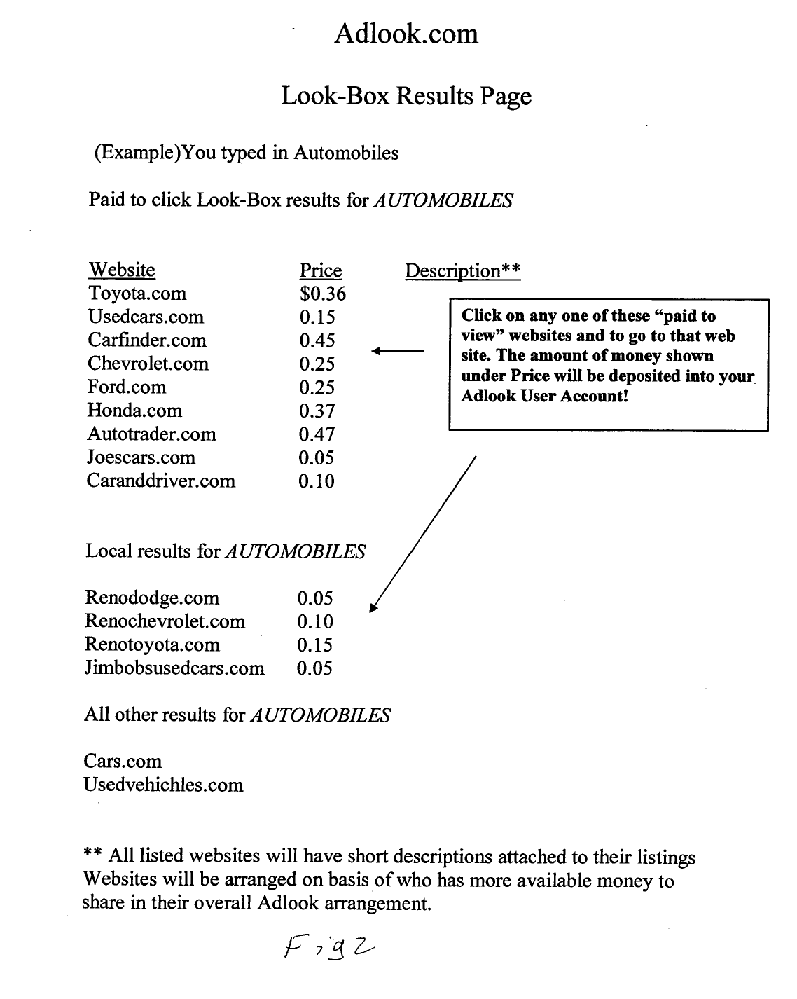

FIG. 3 shows a representation of a computer screen.

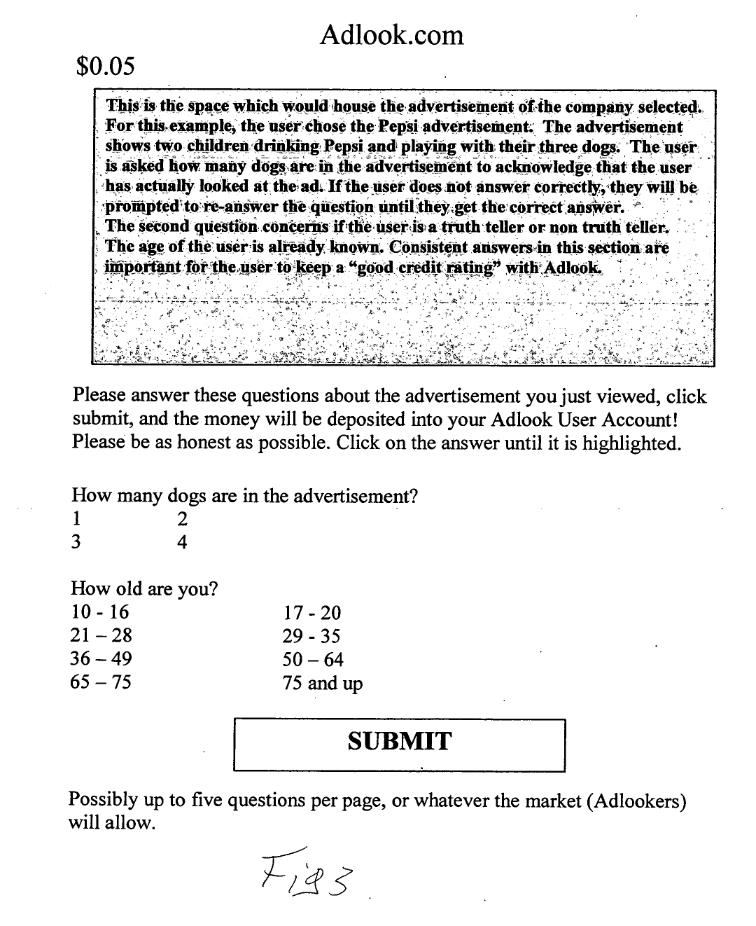

FIG. 4 shows a flow chart.

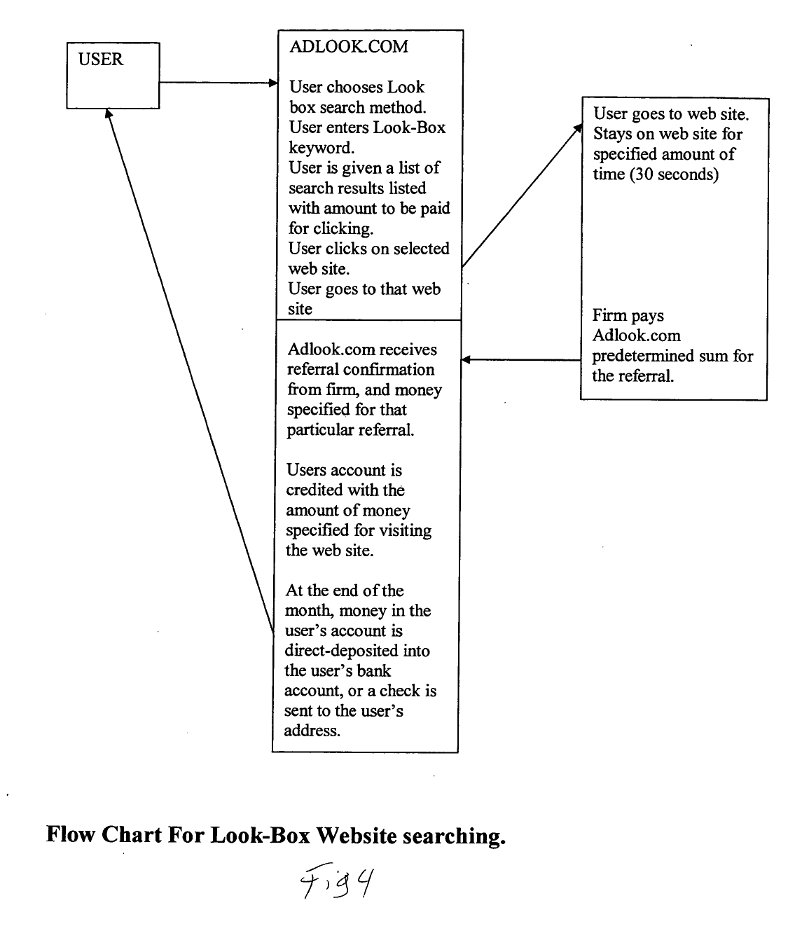

FIG. 5 shows a flow chart.

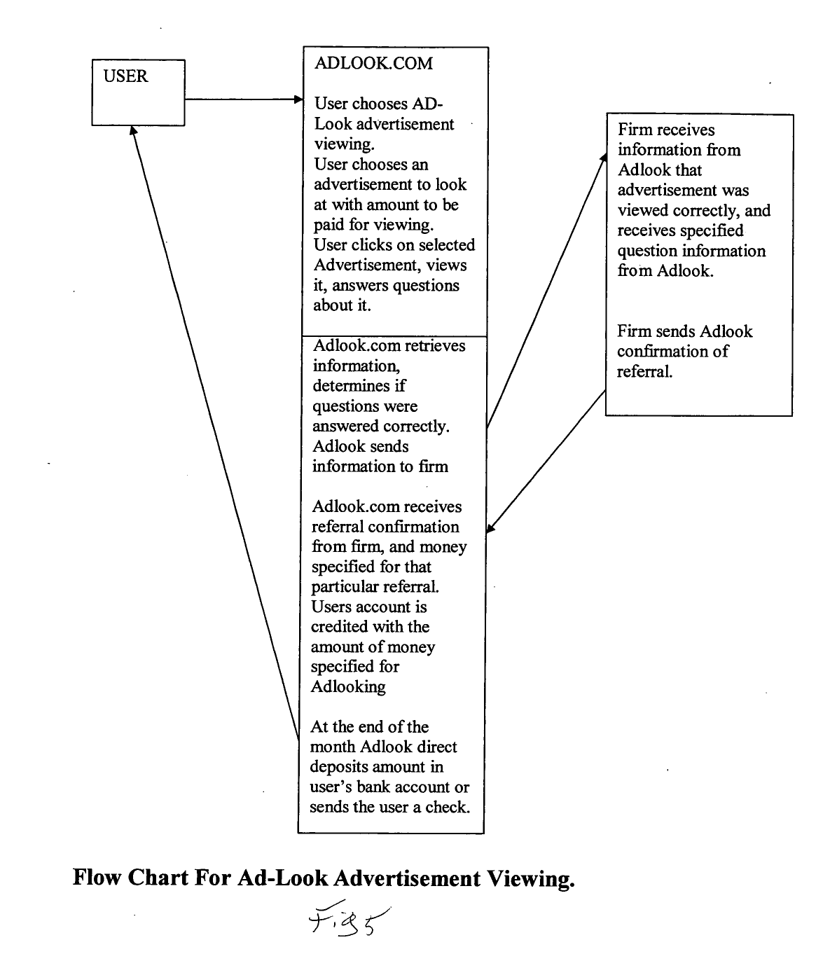

### DESCRIPTION OF PREFERRED EMBODIMENT

The invention is a business method to increase advertisement effectiveness over the Internet by giving customers a portion of the referral fee. By providing customers pay for using the site, the site operator should have more hits than other sites which do not pay. Further, the advertiser seeks as large a pool as possible to be exposed to their ad, thus the revenues of a site using this method even before a client clicks through to an advertiser's site should be greater, just as a commercial during Monday night football costs more than a commercial during a local gardening show.

Another part of the invention is to provide the prospective customer with a schedule of referral fees. The customer provides demographic which generates a profile that can be provided to the advertiser. The accuracy of the profile determines payment. The check or wire will only be sent to one address. Further, accuracy checks on subjective profile components are monitored by queries. A person may be asked how old he is. If he doesn't answer in the same range or the one just above it as is reflected by his stored profile, then his veracity may be questioned. Veracity scores can be used to determine payment or even expulsion from the system. No other system of advertising will give the advertiser the level of honest information about the customer outside an expensive focus group study, where honesty is still not guaranteed.

The method includes security that the customer is actually absorbing the click through. The ad will come up and a question may follow, like how many dogs in the ad. In order to see the dogs or to answer the question, the ad must be at least reviewed, not just glanced at. Incorrect answers are recorded and may reflect on a poor attentiveness score of the customer. These elements of security attempt to confirm the transaction of an advertisement. The advertiser, through the site, gives money in exchange for the attention of a profiled individual.

In an alternate embodiment ads can be directed to certain profiles of individuals. Thus, an advertiser can direct ads to persons of certain geographical or age limits based upon the profile data stored. The prospective customer still has the right to choose whether he will agree to take the fee and refer himself to the advertiser. Even if he chooses to go, he may or may not choose to buy the goods or services offered. To be paid, he must give the ad a fair review confirmed by a timer or other confirmation means. The advertiser gets a person who at least has the profile of one who is profit motivated, somewhat internet savvy and will give a more intense review of the ad than the average viewer of a state of the art ad. The advertiser has a unique opportunity to close a deal and to perhaps incentivize a deal right at the point of sale. A company is selling shoes and offering one dollar to click through. The company has an over stock of size 12. The company can make the sale if they know that the person's shoe size is 12 and can refer that bit of information to a screen that offers a 50% discount available for a limited time. The invention contemplates the advertiser providing a profile of their customers, which is cross matched with the profile of the customers, to generate a list of likely candidates. If the advertiser had such a list their chances of sales impact would be far greater. Further, statistically the ads being referred would be most appealing to the customers. Further, as described above, over stocks or other inefficiencies could be dealt with quickly. The advertiser could have the opportunity to update their profile electronically by changing parameters such as geography, age or income range.

The system can also track and catagorize the clicking habits of the customer. Interests can show up by one's actions. If a customer always checks car deals, particularly when showing an equivalent referral fee to clothing, then an interest is indicated. Further, recording of an order of sites chosen will indicate a preference. The data can be readily analyzed to show a tendency, if not a full preference, by using this information that is tracked to each customer. The money that a customer accumulates is reflected in a tally available to the customer. The amount can be transferred to a bank account on a regular basis.

In an alternate embodiment the customer has an accumulated credit that can be used to purchase items or services offered by advertisers as the funds are clearly available and secure and the advertiser can be credited after confirmation of shipment. The amount can be provisionally set aside so that it can't be spent more than once and tracking confirmation can be automated from FED-X or UPS as a back up to receipt in good condition confirmation by the customer.

In an alternate embodiment an ad button that appears on a website would permit a customer to click such button and be transported to an advertisement with attention evaluation means like the timer or queries. The button may, in one embodiment, identify the customer to make sure that an account and profile has been developed for the user. The invention contemplates providing a code number or a code word that may lead to farther payment. Example: A local auto dealer has profiled a 100-mile radius and offered a referral fee to the operator for an ad to go to people in the region. A portion of the fee is offered to customers. Upon clicking and seeing (and hearing) the ad, the customer might learn of a special offer for more money if a test drive is taken. Thus, the dealer got to the people most likely to buy and offered more money to get them on the lot without risking making the offer to many dead-end looky loos.

Obviously, numerous (additional) modifications and variations of the present invention are possible in light of the above teachings. It is, therefore, to be understood that within the scope of the appended claims, the invention may be practiced otherwise than as specifically described herein.

1. A business method for advertising on the internet comprising the steps of
presenting a schedule of referral fees available to customers for clicking through to advertiser's ads, presenting said click-though means, upon execution of said click through by said customer, directing a portion of a payment from said advertiser to said customer.

2. A business method as described in claim 1 further comprising the step of confirming attentiveness of said customer.

3. A business method as described in claim 2 wherein said step of confirmation comprises propounding a query with regard to the ad and having said customer answer said query.

4. A business method as described in claim 2 wherein said step of confirmation comprises means for timing the exposure of said customer to said advertisement.

5. A business method as described in claim 1 further comprising the step of collecting information from said customer.

6. A business method as described in claim 5 wherein said step of collecting includes data input by said customer to a data file held in the memory system of an operator.

7. A business method as described in claim 5 wherein said step of collecting includes recording web activity of a customer and analysis of said data to identify tendencies of said customer.

8. A business method as described in claim 5 further comprising the step of providing at least part of said information collected from said customer.

9. A business method as described in claim 5 further comprising the step of targeting certain advertisements to said customer based upon said information collected.

10. A business method as described in claim 5 further comprising the step of verifying customer information.

11. A business method as described in claim 5 wherein said step of verifying comprises further inquiry and correlation of present and recorded information.

12. A business method as described in claim 10 further comprising a step of rating a customers veracity based upon said verification of said information.

13. A business method as described in claim 1 wherein said step of directing includes payment of customer portion of proceeds to customers benefit.

14. A business method as described in claim 13 wherein payment comprises the allocation of customer proceeds at the direction of the customer to at least one advertiser as consideration for a transaction held provisionally until delivery is confirmed.

15. A business method as described in claim 9 wherein said step of targeting comprises gathering a profile of target from said advertiser and cross matching elements of said profile with that of customers.

16. A business method as described in claim 1 where in the presentation is a button on a website which leads to at least one ad and results in crediting a customers account with at least a portion of said payment.

17. A business method as described in claim 1 further comprising an offer for further consideration for an act and means to verify execution of said act.

18. A business method as described in claim 17 wherein and ad offers consideration for going to a sales premises and confirms such act by transmitting code means.

19. A business method as described in claim 1 further comprising means to lock out a customer from receiving consideration for reviewing ads more often than limited.

20. A business method as described in claim 1 further comprising a timer to limit the access to a website.
